(19) United States
(12) Patent Application Publication
(10) Pub. No.: US 2024/0383770 A1
(43) Pub. Date: Nov. 21, 2024

(54) DOPED CATHODE ACTIVE MATERIALS AND METHODS THEREOF

(71) Applicant: Tesla, Inc., Austin, TX (US)

(72) Inventors: Jianyu Li, Mountain View, CA (US); Sanketh Gowda, Fremont, CA (US); Vineet Haresh Mehta, Mountain View, CA (US)

(21) Appl. No.: 18/689,756

(22) PCT Filed: Jan. 10, 2023
(86) PCT No.: PCT/US2023/010502

§ 371 Date: Mar. 6, 2024

Related U.S. Application Data
(60) Provisional application No. 63/266,719, filed on Jan. 12, 2022.

(51) Int. Cl. C01G 51/00; H01M 10/0525

(52) U.S. Cl. CPC C01G 51/44; H01M 10/0525; C01P 2004/03; C01P 2004/51; C01P 2004/61; C01P 2006/40

(57) ABSTRACT

Doped cathode active materials, and methods of manufacture, are described. The doped cathode active materials enable energy storage devices with improved performances, including but not limited to improved energy densities and capacity retention.

### INCORPORATION BY REFERENCE TO ANY PRIORITY APPLICATIONS

This application is a non-provisional of and claims priority to U.S. Provisional Patent Application No. 63/266,719, entitled “DOPED CATHODE ACTIVE MATERIALS AND METHODS THEREOF,” filed on Jan. 12, 2022, which is hereby incorporated by reference in its entirety and for all purposes.

### BACKGROUND

### Field

The present disclosure relates generally to energy storage devices, and specifically to doped cathode active materials for lithium-ion batteries and processes for forming the same.

### Description of the Related Art

Electrochemical energy storage systems are widely used to provide power to electronic, electromechanical, electrochemical, and other useful devices. Lithium-ion batteries are one of the most common examples of electrochemical energy storage systems and the prevalence of lithium-ion batteries is due to their higher energy density when compared to other electrochemical energy storage systems. A lithium-ion battery consists of four main components: a cathode electrode, anode electrode, electrolyte, and separator, and much of the success of lithium-ion batteries is attributed to the development of high-energy density electrodes.

Some cathode electrodes in lithium-ion batteries are fabricated from first row transition metal oxides, and some examples of cathode active materials include lithium cobalt oxide (LCO), lithium nickel manganese cobalt oxide (NMC), lithium manganese oxide (LMO), and lithium iron phosphate (LFP). However, many cathode active materials have drawbacks when used in lithium-ion batteries, including a significant loss of charge capacity over repeated charge/discharge cycles.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

In a first aspect, a doped cathode active material is provided. The doped cathode active material includes the chemical formulas Li₁₊ₐTm_{1-a-b}M_{b}O_{c} and Li(Tm)_{2-b}M_{b}O_{c}; where Tm is a transition metal element, M is a dopant element, a is a value of or between 0 and 0.3, b is a value of or between 0 and 0.3, and c is a value of or between 2 and 4.

In another aspect, a doped cathode active material is provided. The doped cathode active material includes the chemical formulas Li₁₊ₐTm_{1-a-b}M_{b}O_{c} and Li(Tm)_{2-b}M_{b}O_{c}; where Tm is a transition metal element, M is a dopant element, a is a value of 0 to 0.3, b is a value of 0.001 to 0.3, and c is a value of 2 or 4.

In some embodiments, the transition metal element is selected from the group consisting of Ni, Mn, Ti, Co, and combinations thereof. In some embodiments, the transition metal element is selected from the group consisting of Ni, Mn, and combinations thereof. In some embodiments, the transition metal element is NiₓMn₁₋ₓ, where x is a value from 0.4 to 0.8. In some embodiments, the compound has the composition of chemical formula LiNiₓMn₁₋ₓM_{b}O₂. In some embodiments, the dopant element is a metal selected from the group consisting of Al, Ca, B, Mg, Ti, Ta, Zr, Mo, W, Y, Co, Na, and combinations thereof. In some embodiments, the dopant element is a metal selected from the group consisting of Al, Ca, Mg, Ti, Ta, Co, and combinations thereof. In some embodiments, the dopant element is a metal selected from the group consisting of Al, Ca, Mg, Ti, Ta, Co, W, Zr, and combinations thereof. In some embodiments, the doped cathode active material has a tap density of at least about 2.24 g/cc. In some embodiments, the doped cathode active material has a tap density of at least about 1 g/cc. In some embodiments, a is a value of 0 to 0.15. In some embodiments, b is a value of 0.001 to 0.08.

In some embodiments, an electrode film includes the doped cathode active material is provided. In some embodiments, the electrode film is disposed over a current collector forming a cathode electrode. In some embodiments, an energy storage device is provided. In some embodiments, the energy storage device includes the cathode electrode, a separator, an anode electrode, an electrolyte, and a housing, where the electrolyte, the cathode electrode, the separator, and the anode electrode are positioned within the housing. In some embodiments, the energy storage device is a battery. In some embodiments, the energy storage device is configured to have a discharge capacity retention of at least about 80% after 30 cycles at a rate of C/3. In some embodiments, an operating voltage of the energy storage device is about 4.35V.

In a second aspect, a method for preparing a doped cathode active material is provided. The method includes mixing a transition metal precursor, a dopant material, and a lithium source to form an active material mixture, and heating the active material mixture to form a doped cathode active material.

In some embodiments, the dopant material includes a plurality of nanoparticles. In some embodiments, the nanoparticles include a D₅₀ size distribution of less than about 100 nm. In some embodiments, the dopant material includes a plurality of particles. In some embodiments, the particles include a D₅₀ size distribution about 2 μm to about 3 μm. In some embodiments, the particles include a D₅₀ size distribution about 1 μm to about 5 μm. In some embodiments, the dopant material is selected from the group consisting of: a metal, a metal oxide, a metal hydroxide, a metal carbonate, a metal bicarbonate, and combinations thereof. In some embodiments, the dopant material includes a metal element is selected from the group consisting of: Al, Ca, B, Mg, Ti, Ta, Zr, Mo, W, Y, Co, Na, and combinations thereof. In some embodiments, the metal element is selected from the group consisting of: Al, Ca, Mg, Ti, Ta, Co, Zr, Na, W, Zr, and combinations thereof. In some embodiments, the metal element is selected from the group consisting of: Al, Ca, Mg, Ti, Ta, Co, Zr, Na, and combinations thereof. In some embodiments, the dopant material is selected from the group consisting of: Al₂O₃, Ta₂O₅, TiO₂, Co₂O₃, Ta, Ca(OH)₂, NaHCO₃, and combinations thereof. In some embodiments, the dopant material is selected from the group consisting of: Al₂O₃, Ta₂O₅, TiO₂, Co₂O₃, WOₓ, Ta, Ca(OH)₂, NaHCO₃, and combinations thereof.

In some embodiments, the transition metal precursor is a spherical transition metal precursor. In some embodiments, the transition metal precursor is selected from the group consisting of a transition metal oxide, a transition metal hydroxide, a transition metal carbonate, and combinations thereof. In some embodiments, the transition metal precursor includes a transition metal element selected from the group consisting of: Ni, Mn, Ti, Co, and combinations thereof. In some embodiments, the transition metal precursor is selected from the group consisting of: NiₓMn₁₋ₓ(OH)₂, NiₓMn₁₋ₓCO₃, and combinations thereof, wherein x is from 0.5 and 0.7.

In some embodiments, the lithium source is selected from the group consisting of: LiOH.H₂O, Li₂CO₃, and combinations thereof. In some embodiments, the molar ratio of the lithium source:dopant material is about 1:0.005 to about 1:0.1. In some embodiments, the molar ratio of the lithium source:dopant material is about 1:0.0005 to about 1:0.1. In some embodiments, the molar ratio of the transition metal precursor:dopant material is about 1:0.001 to about 1:0.1. In some embodiments, the transition metal precursor and the dopant material are pre-mixed to form a precursor mixture, and the precursor mixture is mixed with the lithium source to form the active material mixture. In some embodiments, the lithium source is a lithium salt. In some embodiments, the lithium salt is selected from the group consisting of: LiOH.H₂O, Li₂CO₃, and combinations thereof.

In some embodiments, the precursor mixture is pre-heated. In some embodiments, pre-heating is performed at a temperature of about 400-600° C. In some embodiments, the precursor mixture is pre-heated for a duration between 3-7 hours. In some embodiments, pre-heating is performed in an atmosphere comprising oxygen. In some embodiments, pre-heating is performed in air. In some embodiments, the active material mixture is heated at a temperature of about 800-1000° C. In some embodiments, the active material mixture is heated at a temperature of about 700-1000° C. In some embodiments, the active material mixture is heated for a duration of between 5-15 hours. In some embodiments, the active material mixture is heated for a duration of between 3-15 hours. In some embodiments heating is performed in an atmosphere comprising oxygen. In some embodiments, heating is performed in air. In some embodiments, heating is performed under gas flow.

All of these embodiments are intended to be within the scope of the invention disclosed herein. These and other embodiments will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is a schematic depicting a process of forming a doped cathode active material, according to some embodiments.

FIG. 2A is an SEM image of a doped cathode active material, according to some embodiments.

FIG. 2B is SEM images of undoped and doped cathode active materials, according to some embodiments.

FIG. 3 is a bar graph illustrating the impact of several dopants on the normalized tap density of the cathode active material, according to some embodiments.

FIG. 4 is a bar graph illustrating the impact of several dopants on the normalized energy of a half cell, according to some embodiments.

FIG. 5 is a bar graph illustrating the impact of several dopants on the percent of charge retention of a half cell, according to some embodiments.

FIG. 6 is a bar graph illustrating the impact of different amounts of a dopants on the first cycle efficiency in a half cell test, according to some embodiments.

FIG. 7 is a graph illustrating the impact of different dopants on the energy loss of a full cell, according to some embodiments.

### DETAILED DESCRIPTION

Provided herein are various embodiments of a doped cathode active material with improved energy density and capacity retention, and methods for preparing the doped cathode active material. Doping of cathode active materials, for example doping of nickel manganese oxide cathode active materials (e.g., about 60% nickel content), may allow for improved electrode capacities, and improved electron transport while minimizing the use of costly elements such as cobalt.

In certain embodiments, the doped cathode active material comprises lithium (Li), a transition metal element (Tm), a dopant element (M), and oxygen (O). In some embodiments, the doped cathode active material has the composition L₁₊ₐTm_{1-a-b}M_{b}O_{c}, Li(Tm)_{2-b}M_{b}O_{c}, and combinations thereof.

In certain embodiments, a precursor mixture is formed from a transition metal precursor and a dopant material. In some embodiments, the dopant material is selected from a metal (M), metal oxide (M_{y}O_{z}), a metal hydroxide (M_{y}(OH)_{z}), a metal carbonate (MCO₃), a metal bicarbonate (MHCO₃), and combinations thereof, wherein “M” represents a metal and “y” and “z” are values which create a neutrally charged dopant material. In some embodiments, the dopant material comprises a metal (“M”) selected from aluminum (Al), calcium (Ca), boron (B), magnesium (Mg), titanium (Ti), tantalum (Ta), zirconium (Zr), molybdenum (Mo), tungsten (W), yttrium (Y), cobalt (Co), sodium (Na), and combinations thereof.

In some embodiments, the precursor mixture is mixed with a lithium source and heated to form a doped cathode active material, wherein the doped cathode active material demonstrates an improved tap density. In some embodiments, a cathode electrode is formed from the doped cathode active material and an electrochemical energy storage system is formed using the cathode electrode, wherein the electrochemical energy system demonstrates improved cycle life and energy density. The use of a dopant material in a cathode active material results in improvements in the energy and cycle life of an electrochemical energy storage system.

### Doped Cathode Active Material

Cathode active materials may be doped to improve the performance of the cathode electrodes. In some embodiments, the cathode active material is selected from a layered oxide system (Li(Tm)O₂), a spinel system (Li(Tm)₂O₄), a lithium-rich system (Li₁₊ₓ(Tm)₁₋ₓO₂), and combinations thereof. In some embodiments, “x” is, or is about, 0, 0.1, 0.2, 0.3, 0.4, 0.5, 0.55, 0.6, 0.7, 0.75, 0.8, 0.9 or 1, or any range of values therebetween. For example, in some embodiments, “x” is a numerical value from 0 to 1, from 0 to 0.5, or from 0 to 0.33. Cathode active materials, for example, such as those described herein, may be doped with a dopant element to form a doped cathode active material. In some embodiments, the doped cathode active material comprises lithium (Li), a transition metal element (Tm), a dopant element (M), and oxygen (O). In some embodiments, the doped cathode active material has the composition Li₁₊ₐTm_{1-a-b}M_{b}O_{c}, Li(Tm)_{2-b}M_{b}O_{c}, and combinations thereof.

In some embodiments, the transition metal element (“Tm”) is selected from nickel (Ni), manganese (Mn), titanium (Ti), cobalt (Co), and combinations thereof. In some embodiments, the transition metal element (“Tm”) is selected from nickel (Ni), manganese (Mn), cobalt (Co), and combinations thereof. In some embodiments, the transition metal element (“Tm”) is selected from nickel (Ni), manganese (Mn), and combinations thereof. In some embodiments, the transition metal element (“Tm”) does not include or substantially does not include cobalt (Co).

In some embodiments, a dopant element (“M”) includes a metal selected from aluminum (Al), calcium (Ca), boron (B), magnesium (Mg), titanium (Ti), tantalum (Ta), zirconium (Zr), molybdenum (Mo), tungsten (W), yttrium (Y), cobalt (Co), sodium (Na), and combinations thereof. In some embodiments, a dopant element (“M”) includes a metal selected from aluminum (Al), calcium (Ca), magnesium (Mg), titanium (Ti), tantalum (Ta), zirconium (Zr), tungsten (W), cobalt (Co), and combinations thereof. In some embodiments, a dopant element includes a metal selected from aluminum (Al), calcium (Ca), magnesium (Mg), titanium (Ti), cobalt (Co), and combinations thereof. In some embodiments, a dopant element (“M”) includes a metal selected from aluminum (Al), magnesium (Mg), titanium (Ti), zirconium (Zr), and combinations thereof. In some embodiments, a dopant element (“M”) includes a metal selected from tantalum (Ta), tungsten (W), and combinations thereof. In some embodiments, the doped cathode active material includes, includes at least, or includes at most, 1, 2, 3, 4, 5, 6, 7, 8, 9, 10, 11, 12, 13, 14 or 15 dopant elements, or any range of values therebetween.

In some embodiments, “a” is, or is about, 0, 0.001, 0.005, 0.01, 0.02, 0.03, 0.04, 0.05, 0.06, 0.07, 0.08, 0.09, 0.1, 0.12, 0.15, 0.2, 0.25, 0.3, 0.35, 0.4, 0.45 and 0.5, or any range of values therebetween. For example, in some embodiments, “a” is a numerical value from 0 to 0.5, from 0 to 0.15, or from 0 to 0.05. In some embodiments, “b” is, or is about, 0, 0.001, 0.005, 0.01, 0.02, 0.03, 0.04, 0.05, 0.06, 0.07, 0.08, 0.09, 0.1, 0.15, 0.2, 0.25, 0.3, 0.35, 0.4, 0.45 and 0.5, or any range of values therebetween. For example, in some embodiments, “b” is a numerical value from 0 to 0.5, from 0.001 to 0.3, or from 0.001 to 0.08. In some embodiments, “c” is, or is about, 1, 2, 3, 4 or 5, or any range of values therebetween. For example, in some embodiments, “c” is a numerical value from 1 to 4, or from 2 to 4. In some embodiments, “c” is, or is about, 2 or 4. In some embodiments, the transition metal element comprises, or comprises about, 40 mol. %, 45 mol. %. 50 mol. %. 55 mol. %, 60 mol. %, 65 mol. %, 70 mol. %, 75 mol. % or 80 mol. % nickel, or any range of values therebetween. In some embodiments, the transition metal element is or comprises NiₓMn₁₋ₓ. In some embodiments, x is a value of, or of about, 0.1, 0.2, 0.3, 0.4, 0.5, 0.55, 0.6, 0.65, 0.7, 0.75, 0.8, 0.85, 0.9, 0.95 or 1, or any range of values therebetween. For example, in some embodiments, “x” is a numerical value from 0 to 0.95, from 0.45 to 0.75, from 0.55 to 0.74, or from 0.6 to 0.7. In some embodiments, the doped cathode active material includes less than or less than about 1 at. %, 2 at. %, 3 at. %, 4 at. %, 5 at. %, 6 at. %, 7 at. %, 8 at. %, 10 at. %, or 15 at. % of cobalt. In some embodiments, the doped cathode active material does not include or substantially include cobalt. In some embodiments, the doped cathode active material has the formula LiNiₓMn₁₋ₓM_{b}O₂.

In some embodiments, the doped cathode active material has a tap density of, of about, of at least, or of at least about, 0.5 g/cc, 0.7 g/cc, 0.8 g/cc, 0.9 g/cc, 1 g/cc, 1.2 g/cc, 1 4 g/cc, 1.6 g/cc, 1.8 g/cc, 2 g/cc, 2.2 g/cc, 2.24 g/cc, 2.4 g/cc, 2 6 g/cc, 2.9 g/cc, 3 g/cc, or any range of values therebetween. In some embodiments, the doped cathode active material has a tap density of, of about, of at least, or of at least about 1 g/cc or 2.24 g/cc.

In some embodiments, the doped cathode active material is composed of plurality of spherical particles. In some embodiments, the spherical particles have a diameter (e.g. D₅₀ diameter) of, or of about, 0.1 μm, 0.5 μm, 1 μm, 2 μm, 4 μm, 8 μm, 10 μm, 15 μm, 16 μm, 20 μm, 30 μm, 32 μm, 35 μm, 40 μm, 50 μm or 60 μm, or any range of values therebetween. For example, in some embodiments the D₅₀ diameter of the plurality of spherical particles is about 1 μm to about 50 μm. In some embodiments, the spherical particles of the cathode active materials are aggregates of smaller particles. In some embodiments, the smaller particles have a diameter (e.g. D₅₀ diameter) of, or of about, 0.005 μm, 0.01 μm, 0.02 μm, 0.04 μm, 0.05 μm, 0.08 μm, 0.10 μm, 0.15 μm, 0.16 μm, 2 μm, 2.40 μm, 2.80 μm, 3.20 μm, 3.60 μm, 4 μm, 4.2 μm, 4.4 μm, 4.5 μm, 4.6 μm, 4.8 μm, 5 μm or 6 μm, or any range of values therebetween. For example, in some embodiments the D₅₀ diameter of the smaller particles is about 0.01 μm to about 5 μm, about 0.01 μm to about 4 μm, about 2 μm to about 3 μm. In some embodiments, the size of the smaller particle may be tuned by the types and the amounts of dopants. In some embodiments, the morphology and/or surface area of the cathode active material can be modified by adding a secondary dopant and/or controlling the amount of the secondary dopant in addition to adding a primary dopant. In some embodiments, the smaller particles are packed more closely and are senser by adding the secondary dopant and/or increasing the amount of the secondary dopant in addition to the primary dopant.

Doped cathode active materials may be formed utilizing precursor materials, precursor mixtures and active material mixtures. In some embodiments, a precursor mixture is formed from a transition metal precursor and a dopant material. In some embodiments, the precursor materials, precursor mixtures and/or active material mixtures do not include or substantially include cobalt. In some embodiments, the transition metal precursor is a spherical transition metal precursor. In some embodiments, the transition metal precursor is selected from a metal oxide (TmₚO_{q}), a metal hydroxide (Tmₚ(OH)_{q}), a metal carbonate (Tmₚ(CO₃)_{q}), and combinations thereof, wherein “Tm” represents a transition metal element and “p” and “q” are values which create a neutrally charged transition metal precursor. In some embodiments, the transition metal precursor comprises a transition metal element (“Tm”) selected from nickel (Ni), manganese (Mn), titanium (Ti), cobalt (Co), and combinations thereof. In some embodiments, the transition metal precursor comprises a transition metal element (“Tm”) selected from nickel (Ni), manganese (Mn), cobalt (Co), and combinations thereof. In some embodiments, the transition metal element (“Tm”) is selected from nickel (Ni), manganese (Mn), and combinations thereof. In some embodiments, the transition metal element (“Tm”) does not include or substantially include cobalt (Co). In some embodiments, the transition metal precursor is selected from NiₓMn₁₋ᵣ(OH)₂, NiᵣMn₁₋ᵣCO₃, and combinations thereof. In some embodiments, “r” is, or is about, 0, 0.1, 0.2, 0.3, 0.4, 0.5, 0.55, 0.6, 0.65, 0.7, 0.75, 0.8, 0.85, 0.9, 0.95 or 1, or any range of values therebetween. For example, in some embodiments, “r” is a numerical value between 0 and 1, between 0.55 and 0.75, between 0.45 and 0.75, or between 0.6 and 0.7. In some embodiments the precursor mixture comprises, or comprises about, 75 wt. %, 80 wt. %, 85 wt. %, 90 wt. %, 95 wt. % or 100 wt. % of a transition metal precursor, or any range of values therebetween.

In some embodiments, the dopant material is selected from a metal (M), metal oxide (M_{y}O_{z}), a metal hydroxide (M_{y}(OH)_{z}), a metal carbonate (MCO₃), a metal bicarbonate (MHCO₃), and combinations thereof, wherein “M” represents a metal element and “y” and “z” are values which create a neutrally charged dopant material. In some embodiments, “M” is a metal element selected from aluminum (Al), calcium (Ca), boron (B), magnesium (Mg), titanium (Ti), tantalum (Ta), zirconium (Zr), molybdenum (Mo), tungsten (W), yttrium (Y), cobalt (Co), sodium (Na), and combinations thereof. In some embodiments, “M” is a metal element selected from aluminum (Al), calcium (Ca), magnesium (Mg), titanium (Ti), tantalum (Ta), zirconium (Zr), tungsten (W), cobalt (Co), and combinations thereof. In some embodiments, “M” is a metal element selected from aluminum (Al), calcium (Ca), magnesium (Mg), titanium (Ti), cobalt (Co), and combinations thereof. In some embodiments, “M” is a metal element selected from aluminum (Al), magnesium (Mg), titanium (Ti), zirconium (Zr), and combinations thereof. In some embodiments, “M” is a metal element selected from tantalum (Ta), tungsten (W), and combinations thereof. In some embodiments, the dopant material comprises a metal selected from aluminum (Al), calcium (Ca), boron (B), magnesium (Mg), titanium (Ti), tantalum (Ta), zirconium (Zr), molybdenum (Mo), tungsten (W), yttrium (Y), cobalt (Co), sodium (Na), and combinations thereof. In some embodiments, the dopant material comprises a metal selected from aluminum (Al), calcium (Ca), magnesium (Mg), titanium (Ti), tantalum (Ta), zirconium (Zr), tungsten (W), cobalt (Co), and combinations thereof. In some embodiments, the dopant material comprises a metal selected from aluminum (Al), calcium (Ca), magnesium (Mg), titanium (Ti), cobalt (Co), and combinations thereof. In some embodiments, the dopant material comprises a metal selected from aluminum (Al), magnesium (Mg), titanium (Ti), zirconium (Zr), and combinations thereof. In some embodiments, the dopant material comprises a metal selected from tantalum (Ta), tungsten (W), and combinations thereof. In some embodiments the dopant material is a metal oxide selected from Al₂O₃, Ta₂O₅, TiO₂, Co₂O₃, WOₓ, and combinations thereof. WOₓ is a tungsten oxide, including, for example, tungsten(III) oxide, tungsten(IV) oxide, tungsten(VI) oxide, tungsten pentoxide, and combinations thereof. In some embodiments, the dopant material is a metal hydroxide, for example NaHCO₃, Ca(OH)₂ or Mg(OH)₂. In some embodiments, the molar ratio of the transition metal precursor: dopant material is, or is about, 1:0.001, 1:0.002, 1:0.005, 1:0.008, 1:0.01, 1:0.02, 1:0.03, 1:0.04, 1:0.05, 1:0.1 or 1:0.2, or any range of values therebetween. In some embodiments, the dopant material is a powder. In some embodiments, the powder is a plurality of particles. In some embodiments, the particles are nanoparticles. In some embodiments, the nanoparticles have a D₅₀ size distribution of less than about 100 nm. In some embodiments, the particles are micro particles. In some embodiments, the particles have a D₅₀ size distribution of, of about, 0.5 μm, 1 μm, 1.2 μm, 1.4 μm, 1.5 μm, 1.6 μm, 1.8 μm, 2 μm, 2.2 μm, 2.4 μm, 2.5 μm, 2.7 μm, 3 μm, 3.5 μm, 4 μm, 5 μm, 6 μm, or any range of values therebetween. In some embodiments the precursor mixture comprises, or comprises about, 0 wt. %, 1 wt. %, 2 wt. %, 3 wt. %, 5 wt. %, 7 wt. %, 10 wt. %, 15 wt. %, 20 wt. % or 25 wt. % of a dopant material, or any range of values therebetween. In some embodiments the precursor mixture comprises, or comprises about, 0 mol. %, 0.1 mol. %, 0.5 mol. %, 0.8 mol. %, 1 mol. %, 2 mol. %, 3 mol. %, 4 mol. %, 5 mol. %, or 10 mol. % of a dopant material, or any range of values therebetween.

An active material mixture may comprise the precursor mixture and a lithium source. In some embodiments, the lithium source is a lithium salt. In some embodiments, the lithium salt is selected from LiOH.H₂O, Li₂CO₃, and combinations thereof. In some embodiments, the molar ratio of the lithium source: dopant material is, or is about, 1:0.0001, 1:0.0005, 1:0.001, 1:0.002, 1:0.005, 1:0.008, 1:0.009, 1:0.01, 1:0.015, 1:0.02, 1:0.025, 1:0.03, 1:0.035, 1:0.04, 1:0.045, 1:0.05, 1:0.1 or 1:0.2, or any range of values therebetween. In some embodiments the active material mixture comprises, or comprises about, 20 wt %, 25 wt. %, 30 wt. %, 35 wt. %, 40 wt. % or 45 wt. % of a lithium source, or any range of values therebetween. In some embodiments, the molar ratio of the lithium ion in the lithium source: metal ions (including the dopant metal ions and transition metal ions) in precursor mixture is, or is about, 0.8:1,.085:1, 0.9:1, 1:1, 1:1.001, 1:1.005, 1:1.01, 1:1.05, 1:1.08, 1:1.1, 1:1.15, 1:1.2, 1:1.25, 1:1.28, 1:1.3, 1:1.35, 1:1.4 or any range of values therebetween. In some embodiments, the ratio of the lithium source to the dopant material is based on the intended formula of the doped cathode active material.

### Doped Cathode Active Material Formation Process

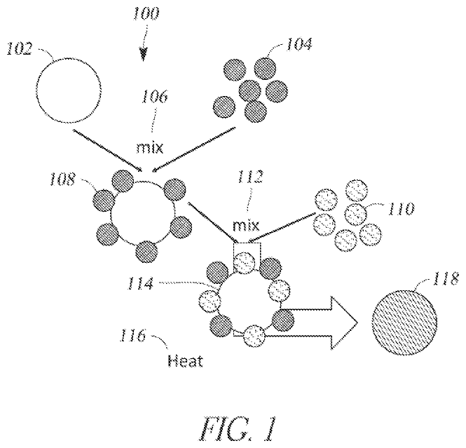

Precursor materials, precursor mixtures and active material mixtures are processed to form doped cathode active materials. FIG. 1 is a flow chart 100 illustrating an example of the doped cathode active material formation process according to some of the embodiments. A transition metal precursor 102 and a dopant material 104 are provided and combined (e.g., mixed) in processing step 106 to form a precursor mixture 108. The precursor mixture 108 is combined (e.g., mixed) in processing step 112 with a lithium source 110 to form an active material mixture 114. The active material mixture 114 is heated (e.g., high temperature calcination) in processing step 116 to form the doped cathode active material 118.

In some embodiments, the precursor mixture is pre-heated after being formed. In some embodiments, the pre-heating is carried out before the precursor mixture being combined (e.g., mixed) with a lithium source o form an active material mixture. In some embodiments, pre-heating is performed at a temperature of, of about, of at least, or at least about, 400° C., 420° C., 440° C., 460° C., 480° C., 500° C., 520° C., 540° C., 560° C., 580° C., 600° C., 625° C., 650° C., 700° C., 800° C. or 1000° C., or any range of values therebetween. In some embodiments, pre-heating is performed in an oxidizing atmosphere or gas, an inert atmosphere or gas, or a reducing atmosphere or gas. In some embodiments, an oxidizing atmosphere is an atmosphere comprising oxygen, for example such as air or an oxygen rich atmosphere. In some embodiments, an oxygen rich atmosphere comprises at least 21 vol % oxygen, at least 23.5 vol % oxygen or at least 25 vol % oxygen. In some embodiments, an inert atmosphere is an atmosphere comprising helium, neon, argon, krypton, xenon, radon, nitrogen, and combinations thereof. In some embodiments, a reducing atmosphere is an atmosphere comprising hydrogen, carbon monoxide, hydrogen sulfide, and combinations thereof. In some embodiments, pre-heating is performed for a duration of, of about, of at least, or at least about, 0, 1, 2, 3, 4, 5, 7, 10, 11, 12, 15, 17, 19 or 20 hours, or any range of values therebetween. In some embodiments, no pre-heating is performed after forming the precursor mixture.

In some embodiments, the active material mixture is heated after being formed. In some embodiments, heating is performed at a temperature of, of about, of at least, or at least about, 600° C., 650° C., 700° C., 725° C., 750° C., 760° C., 780° C., 800° C., 820° C., 840° C., 850° C., 860° C., 880° C., 900° C., 950° C., 1000° C., 1050° C., 1100° C., 1150° C. or 1200° C., or any range of values therebetween. In some embodiments, heating of the active material mixture is performed in an oxidizing atmosphere, an inert atmosphere, or a reducing atmosphere. In some embodiments, the heating temperature is higher than the pre-heating temperature. In some embodiments, an oxidizing atmosphere is an atmosphere comprising oxygen, for example such as air or an oxygen rich atmosphere. In some embodiments, the oxidizing atmosphere is an oxygen atmosphere or oxygen gas. In some embodiments, an oxygen rich atmosphere comprises at least 21 vol % oxygen, at least 23.5 vol % oxygen or at least 25 vol % oxygen. In some embodiments, an inert atmosphere is an atmosphere comprising helium, neon, argon, krypton, xenon, radon, nitrogen, or combinations thereof. In some embodiments, a reducing atmosphere is an atmosphere comprising hydrogen, carbon monoxide, hydrogen sulfide, or combinations thereof. In some embodiments, heating is performed under gas flow. In some embodiments the gas comprises an oxidizing gas, an inert gas, or a reducing gas. In some embodiments, heating is performed for a duration of, of about, of at least, or at least about, 0, 1, 2, 3, 4, 5, 7, 8, 9, 10, 11, 12, 15, 17, 19, 20, 30, 35, 40, 45 or 50 hours, or any range of values therebetween. In some embodiments, the active material mixture is calcinated when heated.

In some embodiments, the process further includes destructing the doped cathode active material. In some embodiments, destructuring comprises a step selected from crushing, milling, and combinations thereof. In some embodiments, the process includes treating the doped cathode active material. In some embodiments, treating comprises a step selected from sieving, washing, filtering, drying, coating, and combinations thereof.

### Energy Storage Device

The doped cathode active material may be use in the preparation of an electrode for an energy storage device. In some embodiments, an electrode film (e.g., doped electrode film) comprises the doped cathode active material. In some embodiments, an electrode comprises a current collector and an electrode film (e.g, doped electrode film). In some embodiments, the electrode is a cathode electrode (e.g., doped cathode electrode).

In some embodiments, an energy storage device includes the doped cathode active material described herein. In some embodiments, the energy storage device comprises a separator, an anode electrode, the cathode electrode (e.g., doped cathode electrode), an electrolyte, and a housing, wherein the electrolyte, separator, anode electrode and cathode electrode are disposed within the housing and the separator is positioned between the anode and cathode electrodes. In some embodiments, an energy storage device is formed by placing an electrolyte, a separator, an anode electrode and the cathode electrode described herein within a housing, wherein the separator is placed between the anode electrode and the cathode electrode. In some embodiments the energy storage device is a battery. In some embodiments the energy storage device is a lithium-ion battery. In some embodiments, the energy storage device comprises an anode electrode sandwiched by two cathode electrodes.

In some embodiments, the energy storage device is configured to a discharge capacity retention after 30 cycles at a rate of C/2, C/3, or C/5 of, of about, of at least, or of at least about, 70%, 75%, 80% 83%, 85%, 90%, 95%, 98% or 99%, or any range of values therebetween. In some embodiments, the energy storage device is configured to a charge capacity retention after 30 cycles at a rate of C/2, C/3, or C/5 of, of about, of at least, or of at least about, 70%, 75%, 80% 83%, 85%, 87%, 90%, 95%, 96%, 97%, 98% or 99%, or any range of values therebetween. In some embodiments, the energy storage device is configured to have an energy loss after 200 cycles at a charge rate of C/2, C/3, or C/5 of, of about, of less than, or of less than about, 20%, 15%, 10%, 9%, 8%, 7%, 6%, 5%, 4% or 3%, or any ranges of values therebetween. In some embodiments, the energy storage device is configured to have an energy loss after 200 cycles at a discharge rate of C/2, C/3, or C/5 of, of about, of less than, or of less than about, 20%, 15%, 10%, 9%, 8%, 7%, 6%, 5%, 4% or 3%, or any ranges of values therebetween. In some embodiments, energy storage device is configured to have a first cycle efficiency at a charge rate of C/2, C/3. Or C/5 of, of about, of at least, or of at least about, 80%, 82%, 84%, 85%, 87%, 89%, 90%, 92%, 94%, 95%, 96% or 97%, or any range of values therebetween. In some embodiments, energy storage device is configured to have a first cycle efficiency at a discharge rate of C/2, C/3. Or C/5 of, of about, of at least, or of at least about, 80%, 82%, 84%, 85%, 87%, 89%, 90%, 92%, 94%, 95%, 96% or 97%, or any range of values therebetween.

In some embodiments, the operating voltage of the energy storage device with the cathode comprising the doped cathode active material is, is about, is at least, is at least about, 4.2V, 4.25V, 4.3V, 4.35V, 4.4V, 4.45V, 4.5V, 4.55V, or 4.6V, or any range of values therebetween. In some embodiments, the operating voltage of the energy storage device with the cathode comprising the doped cathode active material is higher than a normal operating voltage (e.g., 4.2V). A higher operating voltage may increase the energy density and the charge and discharge rates of the energy storage device. In some embodiments, the higher operating voltage is at least partially related to the amount of nickel content in the doped cathode active material. In some embodiments, the amount of nickel content is about 40 mol. % to about 80 mol. % among the transition metal element to achieve a higher-than-normal operating voltage.

### EXAMPLES

Example embodiments of the present disclosure, including processes, materials and/or resultant products, are described in the following examples.

### Example 1

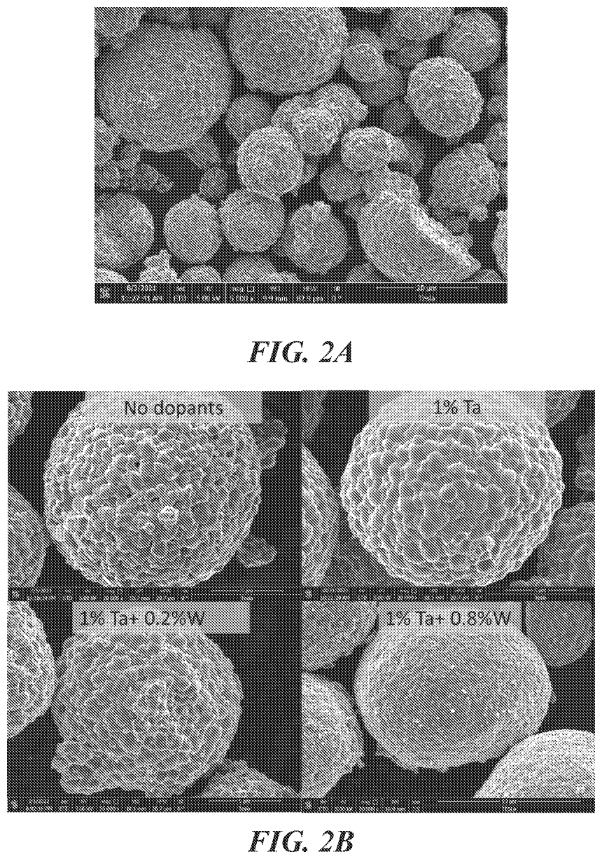

FIG. 2A is an SEM image of a doped cathode active material, according to some of the embodiments. FIG. 2A illustrates that the doped cathode active material is composed of plurality of spherical particles. It can also be seen from FIG. 2A that the spherical particles are aggregates of smaller particles.

FIG. 2B is an SEM image of a cathode active material with no dopants, doped with 1% Ta, doped with 1% Ta and 0.2% W, and 1% Ta and 0.8% W respectively. As shown in FIG. 2B, the morphology and surface area of the cathode active material can be modified by adding a secondary dopant and/or controlling the amount of the secondary dopant in addition to the primary dopant. It can be seen from FIG. 2B that the smaller particles that form the spherical particle of the cathode active material are more closely packed and denser with the addition and increased amount of the secondary dopant.

### Example 2

Doped and non-doped cathode active materials were prepared, and their tap densities were compared. A Ni_{0.65}Mn_{0.35}(OH₂)₂ transition metal precursor was mixed with 1 mol. % TiO₂ (i.e., 1 mol. % Ti) or 1 mol. % Co₂O₃ (i.e., 1 mol. % Co) dopant material at a molar ratio of transition metal:dopant material=1:0.009 to form a precursor mixture, and a transition metal precursor with no doping was also prepared. Some of the precursor mixtures were prebaked at about 500° C. in air or O₂ for 3 hours, and alternatively some of the precursor mixtures were not prebaked. The prebaked precursor mixtures, precursor mixtures that were not prebaked, or undoped transition metal precursor were mixed with a Li₂CO₃ lithium source at a molar ratio of lithium source:dopant material=1:0.009 to form active material mixtures. The active material mixtures were heated at 880-940° C. under air or O₂ flow for 5-15 hours (e.g. 10 hours). The heated active material mixtures were ground and sieved to produce doped and non-doped cathode active materials, wherein the titanium doped active material includes LiNi_{0.643}Mn_{0.347}Ti_{0.01}O₂ and the cobalt doped active material includes LiNi_{0.643}Mn_{0.347}Co_{0.01}O₂. FIG. 3 illustrates the normalized tap density of the cathode active material prepared with prebaking the precursor mixtures and with no dopants, with 1 mol. % Ti, or 1 mol. % Co dopant, respectively. As can be seen in FIG. 3, the tap densities of doped cathode active materials comprising 1 mol. % Ti or 1 mol. % Co were higher than a cathode active material having no dopant. Cathode active materials prepared without prebaking the precursor mixtures showed similar results as those shown in FIG. 3.

### Example 3

Doped and non-doped cathode active materials formed with and without prebaked precursor mixtures were prepared utilizing similar processes to those described in Example 2, wherein 1 mol. % Al₂O₃, 1 mol. % Ca(OH)₂, 1 mol. % Mg (e.g., Mg(OH)₂), 1 mol. % TiO₂ or 1 mol. % Co₂O₃ dopant material was used to dope the cathode active materials. The doped or non-doped cathode active materials were mixed with carbon black and PVDF (poly-(vinylidene fluoride) in N-methyl-2-pyrrolidone to form slurry. The mass ratio of the cathode active material: carbon black:PVDF was 90:5:5. The slurry was casted onto aluminum foil, vacuum dried, and then roll pressed to form 14 mm disks of cathode electrodes. The loading of the cathode active material was about 13 mg/cm² and the density of the cathode electrode was about 3 g/cc. Half-cell coin cells were fabricated using 14 mm cathode electrode disks and lithium metal disks as the anode electrode. The coin cell was assembled in an argon filled glove box by placing the 14 mm disk on top of the large can of the coin cell, followed by stacking a separator, the lithium metal disk, a spacer, a spring, and then the small can of the coin cell together in that order. 80 μL of a 1M LiPF₆ in a 1:4 by mass Fluoroethylene Carbonate/Dimethyl carbonate (FEC/DMC) electrolyte solution was added between the large can and small can of the coin cell. Finally, the large can and small can of the coin cell was crimped together with a coin cell crimper to form a seal.

The coin cells were tested using an Arbin cycler and positioned in a temperature-controlled chamber at 25° C. to ensure that the testing environment was maintained at a constant temperature during testing. The coin cell was left to rest for 3 hours, and then charged and discharged at a constant rate of C/20 for 1 cycle. A CV hold process was applied until the current reached C/50 following a charge, and then the coin cell was charged and discharged at a constant rate of C/3 for 30 cycles. Next, a CV hold process was applied until the current reached C/20 at the end of each charge. Finally, the coin cell was charged and discharged at a constant rate of C/20 for 1 cycle, followed by a CV hold until the current reached C/50 following a charge.

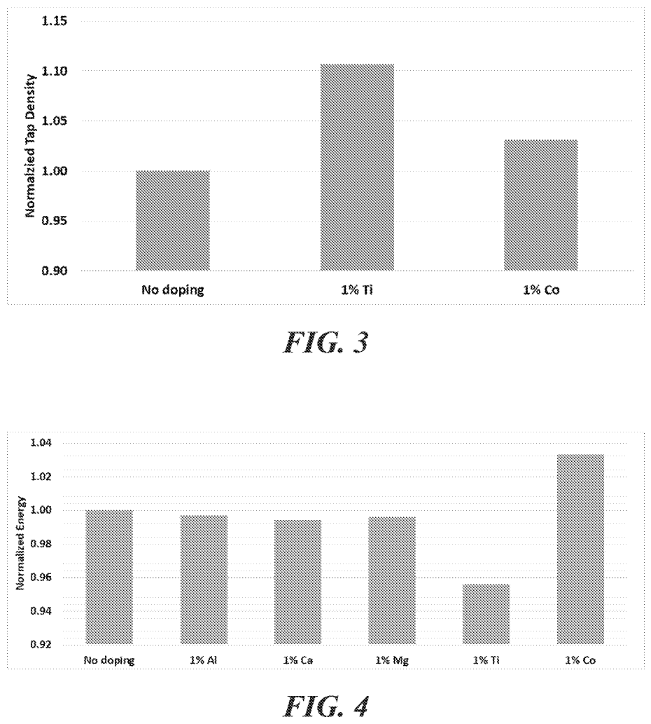

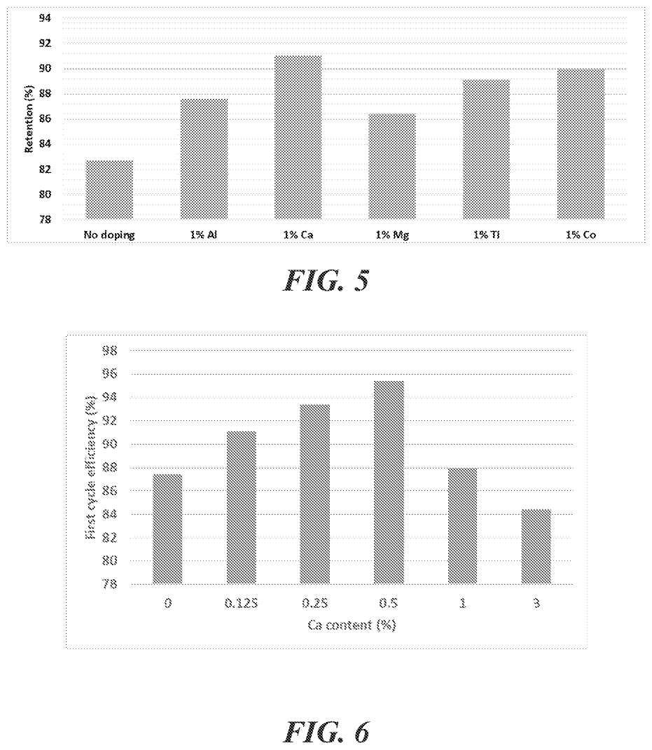

FIGS. 4 and 5 show normalized energy and charge retention results of coin cells described herein with cathodes prepared with prebaking the precursor mixtures and with no doping, 1 mol. % Al, 1 mol. % Ca, 1 mol. % Mg, 1 mol. % Ti or 1 mol. % Co dopant. As can be seen in FIGS. 4 and 5, the energy and capacity retention, respectively, of coin cells comprising dopant materials improved relative to cells without dopant. Coin cells with cathodes prepared without prebaking the precursor mixtures showed similar results as those shown in FIGS. 4 and 5.

FIG. 6 shows the first cycle efficiency of the coin cells described herein with cathodes prepared without prebaking the precursor mixtures and including cathode active material comprising no Ca dopant, 0.125 mol. % Ca, 0.25 mol. % Ca, 0.5 mol. % Ca, 1 mol. % Ca or 3 mol. % Ca dopant. In addition to the Ca dopant, each of the cathode active materials also included 1 mol % Ta and 0.4 mol % Ti as dopants. As can be seen in FIG. 6, the first cycle efficiency of coin cells is improved with 0.125 mol. % Ca, 0.25 mol. % Ca and 0.5 mol. % Ca dopant relative to no Ca dopant.

### Example 4

Full cells (i.e., pouch cells) including the cathode electrode comprising the non-doped or doped cathode active materials prepared without prebaking the precursor mixtures were prepared and tested. Cathode electrodes for the full cells were prepared similarly to those prepared for the half cells as discussed in Example 3, except that the mass ratio of the cathode active material:carbon black:PVDF was 96:2:2, and the loading of the cathode active material was about 18 mg/cm² and the density of the cathode electrode was about 3 g/cc. The cathode electrode was formed on a 54×54 mm disk. Graphite was used as the anode. Full cells were prepared by sandwiching an anode electrode with two cathode electrodes and wrapping each of the electrodes with separators to form an electrode stack. Then the stack was sealed in a pouch bag which was filled with 1.5 g electrolyte. The electrolyte was formed by dissolving 0.9M LiPF₆ and 0.3M LiFSI in 25:5:70 by mass ethylene carbonate/ethyl methyl carbonate/dimethyl carbonate (EC/EMC/DMC) electrolyte solution. The pouch bag was sealed by a hot sealing machine. The full cells were then cleaned with iso-propane wipes. The full cells are assembled in a dry room with a dew point of −25° C.

The full cells were tested using an Arbin cycler and positioned in a temperature-controlled chamber at 40° C. to ensure that the testing environment was maintained at a constant temperature during testing. The full cells were formed by going through a formation process before being tested. The full cells were initially charged to 3.0 V at a constant rate of C/50 and a CV hold process was applied to the full cells for 8 hours. The full cells were then charged to 4.055 V at a constant rate of C/5 and a CV hold process was applied to the full cells until the current reaches C/20, and the full cells rested for 12 hours afterwards. The full cells were formed after being charged and discharged at a rate of C/20.

After formation process, the full cells were tested first by being charged and discharged at constant rate of C/2 for 1 cycle and a CV hold process was applied to the full cells until the current reached C/50 after being charged. Then the cells were charged and discharged at a constant rate of C/2 for 200 cycles and a CV hold process was applied to the full cells until the current reaches C/20 at the end of each charge process.

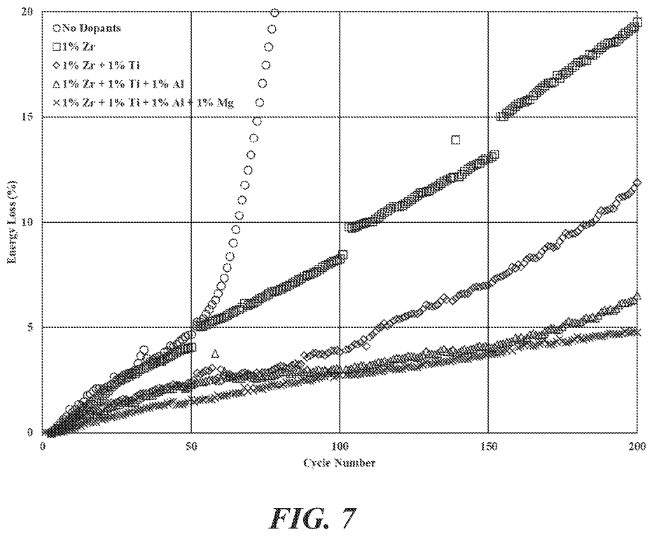

FIG. 7 shows the percentage of energy loss results of the full cells described herein with cathodes comprising no dopants, 1 mol. % Zr dopants, 1 mol. % Zr and 1 mol. % Ti dopants, 1 mol. % Zr, 1 mol. % Ti and 1 mol. % Al dopants, or 1 mol. % Zr, 1 mol. % Ti, 1 mol. % Al and 1 mol % Mg dopants are 19.5%, 12%, 6 5%, and 4.8%. As can be seen in FIG. 7, the energy loss of full cells comprising different types and amount dopant materials were reduced relative to that of the full cells without dopant. In addition, the energy loss of the full cells was reduced to less than 20% with a single dopant after 200 cycles, the energy loss of the full cells was reduced to less than 15% with two dopants after 200 cycles, and the energy loss of the full cells was reduced to less than 10% with three or four different dopants after 200 cycles.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result.

The scope of the present disclosure is not intended to be limited by the specific disclosures of embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

1. A doped cathode active material, comprising a compound having a composition of either chemical formula (I) or chemical formula (II):
Li₁₊ₐTm_{1-a-b}M_{b}O_{c} (I);
Li(Tm)_{2-b}M_{b}O_{c} (II);
wherein:
Tm is a transition metal element;
M is a dopant element;
a is a value of 0 to 0.3;
b is a value of 0.001 to 0.3; and
c is a value of 2 or 4.

2. The doped cathode active material of claim 1, wherein the transition metal element is selected from the group consisting of Ni, Mn, Ti, Co, and combinations thereof.

3. The doped cathode active material of claim 1, wherein the transition metal element is selected from the group consisting of Ni, Mn, and combinations thereof.

4. The doped cathode active material of claim 1, wherein the transition metal element is NiₓMn₁₋ₓ, wherein x is a value from 0.4 to 0.8.

5. The doped cathode active material of claim 4, wherein the compound has the composition of chemical formula LiNiₓMn₁₋ₓM_{b}O₂.

6. The doped cathode active material of claim 1, wherein the dopant element is a metal selected from the group consisting of: Al, Ca, B, Mg, Ti, Ta, Zr, Mo, W, Y, Co, Na, and combinations thereof.

7. The doped cathode active material of claim 1, wherein the dopant element is a metal selected from the group consisting of: Al, Ca, Mg, Ti, Ta, Co, W, Zr, and combinations thereof.

8. (canceled)

9. The doped cathode active material of claim 1, wherein a is a value of 0 to 0.15.

10. The doped cathode active material of claim 1, wherein b is a value of 0.001 to 0.08.

11. An electrode film comprising the doped cathode active material of claim 1.

12. A cathode electrode comprising the electrode film of claim 11 disposed over a current collector.

13. An energy storage device, comprising:
the cathode electrode of claim 12;
a separator;
an anode electrode;
an electrolyte; and
a housing, wherein the electrolyte, the cathode electrode, the separator, and the anode electrode are positioned within a housing.

14. The energy storage device of claim 13, wherein the energy storage device is a battery.

15. The energy storage device of claim 14, wherein the battery is configured to have a discharge capacity retention of at least about 80% after 30 cycles at a rate of C/3.

16. The energy storage device of claim 13, wherein an operating voltage of the energy storage device is about 4.35V.

17. A process for forming the doped cathode active material of claim 1, the process comprising:
mixing a transition metal precursor, a dopant material and a lithium source to form an active material mixture; and
heating the active material mixture to form the doped cathode active material.

18. The process of claim 17, wherein the dopant material comprises a plurality of particles.

19. The process of claim 18, wherein the particles comprise a D₅₀ size distribution of about 1 μm to about 5 μm.

20. The process of claim 17, wherein the dopant material is selected from the group consisting of a metal, a metal oxide, a metal hydroxide, a metal carbonate, a metal bicarbonate, and combinations thereof.

21. (canceled)

22. (canceled)

23. The process of claim 17, wherein the dopant material is selected from the group consisting of: Al₂O₃, Ta₂O₅, TiO₂, Co₂O₃, WOₓ, Ta, Ca(OH)₂, NaHCO₃, and combinations thereof.

24. The process of claim 17, wherein the transition metal precursor is a spherical transition metal precursor.

25. The process of claim 17, wherein the transition metal precursor is selected from the group consisting of: a transition metal oxide, a transition metal hydroxide, a transition metal carbonate, and combinations thereof.

26. (canceled)

27. The process of claim 17, wherein the transition metal precursor is selected from the group consisting of: NiₓMn₁₋ₓ(OH)₂, NiₓMn₁₋ₓCO₃, and combinations thereof, wherein x is from 0.5 and 0.7.

28. The process of claim 17, wherein the lithium source is selected from the group consisting of: LiOH.H₂O, Li₂CO₃, and combinations thereof.

29. The process of claim 17, wherein a molar ratio of the lithium source:dopant material is about 1:0.0005 to about 1:0.1.

30. The process of claim 17, wherein a molar ratio of the transition metal precursor:dopant material is about 1:0.001 to about 1:0.1.

31. The process of claim 17, wherein the transition metal precursor and the dopant material are pre-mixed to form a precursor mixture, and the precursor mixture is mixed with the lithium source to form the active material mixture.

32. (canceled)

33. (canceled)

34. The process of claim 31, wherein the precursor mixture is pre-heated at a temperature of about 400-600° C.

35. (canceled)

36. (canceled)

37. (canceled)

38. (canceled)

39. The process of claim 17, wherein the active material mixture is heated at a temperature of about 700-1000° C.

40. (canceled)

41. (canceled)

42. (canceled)

43. (canceled)
